(19) United States
(12) Patent Application Publication
(10) Pub. No.: US 2020/0342480 A1
(43) Pub. Date: Oct. 29, 2020

(54) MOBILE SCAVENGER HUNT GAME

(71) Applicants: MICHAEL RAMSEY, Humble, TX (US); MICHAEL SCOTT FROST, Humble, TX (US)

(72) Inventors: MICHAEL RAMSEY, Humble, TX (US); MICHAEL SCOTT FROST, Humble, TX (US)

(21) Appl. No.: 16/714,587

(22) Filed: Dec. 13, 2019

Related U.S. Application Data
(63) Continuation of application No. 62/837,607, filed on Apr. 23, 2019.

(51) Int. Cl. G06Q 30/02; A63F 13/55

(52) U.S. Cl. CPC G06Q 30/0209; A63F 13/55; G06Q 30/0212

(57) ABSTRACT

Embodiments of the present invention disclose a method, a computer program product, and a system for informing collectors the locations of houses participating in a collecting event and safely transferring prizes to the collectors. Embodiments of the present invention can be used to receive registration corresponding to each player of a plurality of players, determine a set of active players and a set of inactive players among the plurality of players, determine a transfer request of a prize between a collector and an active player among the set of active players, and execute a transfer based on the determined transfer request.

### CLAIM OF PRIORITY

This application claims the benefit of U.S. Provisional Application No. 62/837,607, filed 23 Apr. 2019. The information contained therein is hereby incorporated by reference.

### BACKGROUND

### 1. Field of the Invention

The present application relates to the field of mobile gaming, and more particularly to displaying a generated player map and a transactional system between participating entities.

### 2. Description of Related Art

Online neighborhood maps are utilized to keep occupants of a neighborhood informed of day to day activities and to raise awareness towards community concerns. Some online neighborhood maps offer a digital social network that can provide a map of occupants of a neighborhood, allow occupants to connect with each other, and can provide a forum for occupants to discuss community topics. During special events, an online neighborhood map can highlight on a map the locations of participating occupants. For example, on Halloween, an online neighborhood map can display on a map of the neighborhood homes of occupants that are actively participating in giving out candy to trick-or-treaters and homes of occupants that are not participating in the event, thus allowing a convenient way of informing trick-or-treaters which homes to approach to collect candy and which houses to leave alone. However, the candy exchange between occupants that are participating in the event and the trick-or-treaters present several shortcomings. In some cases, the candy that trick-or-treaters receive can be a health concern: parents of trick-or-treaters may have a concern in the amount of candy a trick-or-treater may consume or occupants that are participating may only offer candies that could contain an allergy concern to the trick-or-treater.

Although strides have been made to keep trick-or-treaters informed and safe, some shortcoming remain. It is desired to make trick-or-treaters more informed of the occupants that are actively participating and to provide the trick-or-treater a degree of freedom in receiving treats.

### SUMMARY OF THE INVENTION

Embodiments of the present invention disclose a method, a computer program product, and a system for informing collectors the locations of houses participating in a collecting event and safely transferring prizes to the collectors. In one embodiment of the present invention, a method is provided comprising: receiving registration corresponding to each player of a plurality of players; determining a set of active players and a set of inactive players among the plurality of players; determining a transfer request of a prize between a collector and an active player among the set of active players; and executing a transfer based on the determined transfer request.

Ultimately the invention may take many embodiments. In these ways, the present invention overcomes the disadvantages inherent in the prior art.

The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions in so far as they do not depart from the spirit and scope of the present application.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a functional block diagram illustrating an exchange environment, in accordance with an embodiment of the present application;

FIG. 2 is a flowchart depicting operational steps of a Halloween program of exchanging a prize from an active player to a collector, in accordance with an embodiment of the present invention;

FIG. 3 is a flowchart depicting operational steps of determining a transfer request of a prize between the active player and the collector, in accordance with an embodiment of the present invention;

FIG. 4 is an example screenshot of a neighborhood map displaying a set of active players and a region containing a location of a grand prize, in accordance with an embodiment of the present invention; and

FIG. 5 depicts a block diagram of components of the computing system of FIG. 1, in accordance with an embodiment of the present invention.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

Embodiments of the present invention overcomes one or more of the above-discussed problems commonly associated with an online neighborhood map as well as providing a safe prize exchange for a community event. The embodiments of the present invention, and combination thereof, provide solutions for informing collectors (e.g., trick-or-treaters) the locations of houses that have identified and reputable players participating in an event (e.g., Halloween) that are giving away prizes (e.g., candy), thus safely guiding collectors during the event. As described in greater detail later in the specification, embodiments of the present invention identify a set of active players and a set of inactive players participating in an event and display on a map for a plurality of collectors a set of locations corresponding to the active and inactive players. In further embodiments, the map displays a region containing a location of an active player having a grand prize, thus further incentivizing collectors to search for the location of the active player to obtain the grand prize, much akin to an Easter egg hunt. Furthermore, embodiments of the present invention determine and execute a transfer request of a prize between an active player and a collector, thus allowing a safe transfer of prizes and to allow the collector to select an option of redeeming the prize. For example, in some embodiments, a prize can be a coupon voucher that a collector can redeem in purchasing a product of the collector's choice at a local store.

Implementation of embodiments of the invention may take a variety of forms, and exemplary implementation details are discussed subsequently with reference to the figures. Several embodiments may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

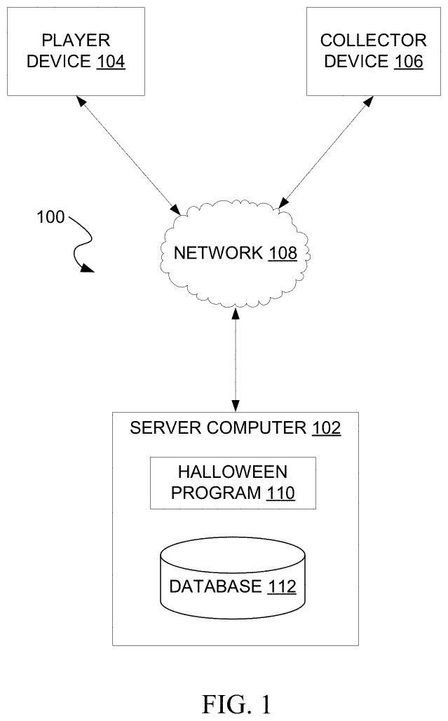

FIG. 1 is a functional block diagram illustrating an exchange environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

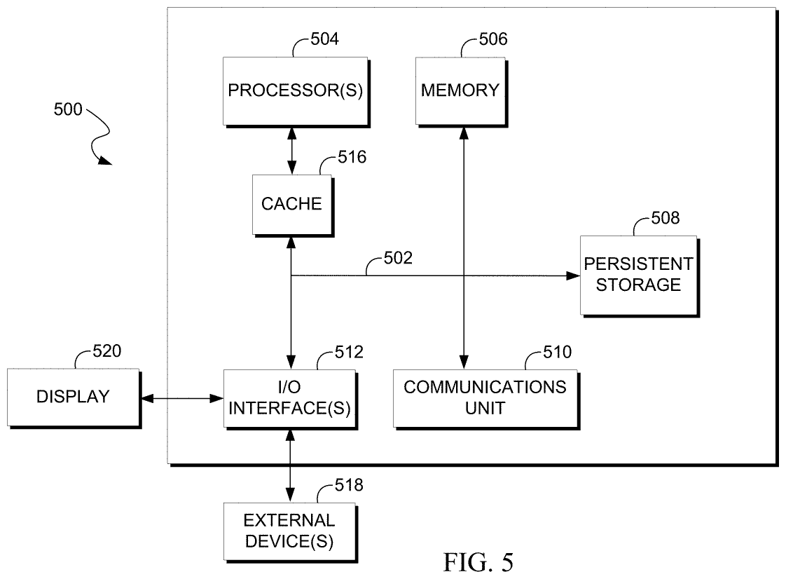

Exchange environment 100 includes server computer 102, player device 104, and collector device 106, all interconnected over network 108. Server computer 102, player device 104, and collector device 106 can be a standalone computing device, a management server, a webserver, a mobile computing device, or any other electronic device or computing system capable of receiving, sending, and processing data. In other embodiments, server computer 102, player device 104, and collector device 106 can represent a server computing system utilizing multiple computers as a server system, such as in a cloud computing environment. In another embodiment, server computer 102, player device 104, and collector device 106 can be a laptop computer, a tablet computer, a netbook computer, a personal computer (PC), a desktop computer, a personal digital assistant (PDA), a smart phone, or any programmable electronic device capable of communicating with various components and other computing devices (not shown) within exchange environment 100. In another embodiment, server computer 102, player device 104, and collector device 106 each represent a computing system utilizing clustered computers and components (e.g., database server computers, application server computers, etc.) that act as a single pool of seamless resources when accessed within exchange environment 100. server computer 102, player device 104, and collector device 106 may include internal and external hardware components capable of executing machine-readable program instructions, as depicted and described in further detail with respect to FIG. 5.

As used herein, player device 104 is associated with a player and collector device 106 is associated with a collector. In one embodiment, player device 104 can display on a display screen of player device 104 a code (e.g., bar code or quick response (QR) code) that is associated with a respective coupon or currency amount stored on an account of a player associated with player device 104. Furthermore, collector device 106 has a camera that scans the code displayed on player device 104, wherein Halloween program 110 identifies the code via camera on collector device 106 by matching the code to the respective coupon or currency amount stored on an account of the player associated with player device 104.

Server computer 102 includes Halloween program 110 and database 112. In general, Halloween program 110 determines a set of active players and a plurality of inactive players participating in an event. As used herein, an “active player” is a player participating in an event wherein the player has selected a declaration via a client program installed on player device 104 (Halloween program 110 subsequently receives the declaration) that indicates that the player is participating in an exchange with a plurality of collectors. As used herein, an “inactive player” is a previously active player participating in an event wherein the player has selected a declaration via the client program installed on player device 104 that indicates that the player is no longer participating in the exchange with the plurality of collectors. As used herein, a collector is a user (e.g., a “trick-or-treaters) that collects prizes (i.e., “treats”). As used herein, a “player” is either an active player, an inactive player, or a collector.

In some embodiments, Halloween program 110 generates a map on collector device 106 corresponding to a plurality of collectors that displays a plurality of locations corresponding to locations of the set of active players. In further embodiments, Halloween program 110 determines an active player has selected a grand prize declaration via the client program, wherein the grand prize declaration indicates that the player has a grand prize to award to a collector among the plurality of collectors. In response to determining an active player has selected a grand prize declaration, Halloween program 110 overlays a region on the generated map wherein the region comprises a location of the active player having the grand prize. Furthermore, Halloween program 110 determines a transfer request of a prize between an active player among the set of active players to a collector of the plurality of collectors and subsequently executes a transfer of the prize from an account of the active player to an account of the collector in response to the transfer request.

Database 112 is a repository for data accessible by Halloween program 110. Database 112 can be implemented with any type of storage device capable of storing data and configuration files that can be accessed and utilized by server computer 102, such as a database server, a hard disk drive, or a flash memory. Database 112 stores a plurality of accounts corresponding to a plurality of players, wherein an account of the plurality of accounts comprises, but is not limited to, a name and address associated with the player, an amount of funds stored in the account associated with the player, and a set of coupon vouchers that are redeemable for store value at a respective store. As used herein, “funds” and “an amount of currency” are used interchangeably. Database 112 also stores a plurality of accounts corresponding to a plurality of collectors, wherein an account of the plurality of accounts corresponding to the plurality of collectors comprises, but is not limited to, a name associated with the player, an amount of funds stored in the account associated with the collector, and a set of coupon vouchers that are redeemable for store value at a respective store. In one embodiment, in response to a transfer request between an active player and a collector, Halloween program 110 transfers a player designated amount of currency and/or a player designated coupon from the account associated with the player to an account of the collector.

In one embodiment, in response to a player selecting to transfer a currency amount from a bank account or credit/debit card account to an account stored on database 112 associated with the player, Halloween program 110 transfers the currency amount from the bank account or credit/debit card account to the account stored on database 112 associated with the player. In an alternative embodiment, in response to a player selecting to purchase a set of coupons associated with a respective store using an associated bank account or credit/debit card account, Halloween program 110 transfers a currency amount equal to the coupon value of the set of coupons from the bank account or credit/debit card account of the player to a respective store account associated with the coupons and transfers the set of coupons to the account of the player.

In one embodiment, in response to a collector selecting to transfer a currency amount from an account associated with the collector stored on database 112 to a bank account or credit/debit card account associated with the collector, Halloween program 110 transfers the currency amount from the account associated with the collector to the bank account or credit/debit card account associated with the collector. In an alternative embodiment, in response to a player selecting a coupon stored in a respective account of the collector, Halloween program 110 prints the coupon to allow the collector to redeem the coupon at a respective store. Alternatively, Halloween program 110 displays on a display screen of collector device 106 a code (e.g., a bar code or a quick response (OR) code that allows a store to scan the code and redeem a store credit amount associated with the coupon for the collector.

Network 108 can be, for example, a telecommunications network, a local area network (LAN), a wide area network (WAN), such as the Internet, or a combination of the three, and can include wired, wireless, or fiber optic connections. Network 108 can include one or more wired and/or wireless networks that are capable of receiving and transmitting data, voice, and/or video signals, including multimedia signals that include voice, data, and video information. In general, network 108 can be any combination of connections and protocols that will support communications among server computer 102, player device 104, collector device 106, and other computing devices (not shown) within exchange environment 100.

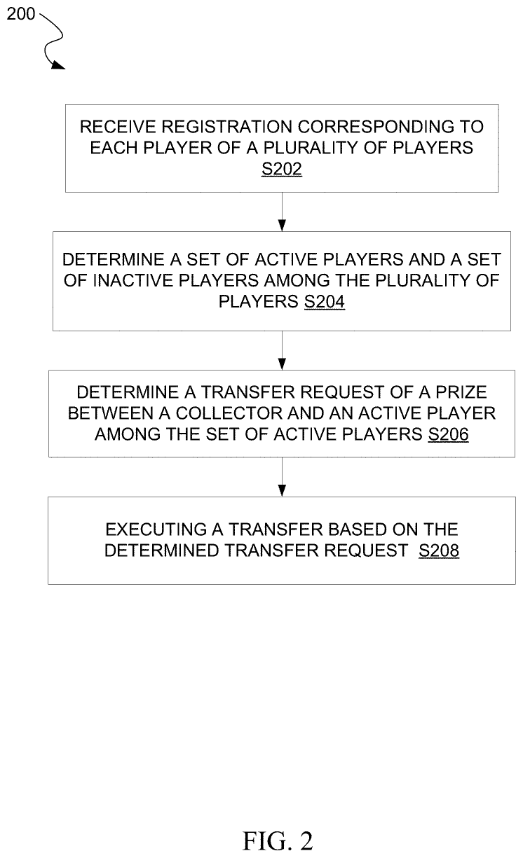

FIG. 2 is a flowchart 200 depicting operational steps of a Halloween program of exchanging a prize from an active player to a collector, in accordance with an embodiment of the present invention.

In step S202, Halloween program 110 receives registration corresponding to each player of a plurality of players. In this embodiment, Halloween program 110 receives registration corresponding to each player of a plurality of players by receiving registration corresponding to each player via either player device 104 or collector device 106, wherein the registrations comprises, but is not limited to, a name of the player, an address of the player, and a player state (e.g., active player, grand prize active player, inactive player, or collector). In a further embodiment, in response to receiving registration corresponding to a player, Halloween program 110 generates an account on database 112 that is associated with the player and subsequently stores the registration corresponding to the player to the account stored on database 112, wherein the generated account allows a player to transfer a currency amount or a set of coupons to and from the account.

In step S204, Halloween program 110 determines a set of active players and a set of inactive players among the plurality of players. In this embodiment, Halloween program 110 determines a set of active players and a set of inactive players among the plurality of players by checking the player state of each player among the plurality of players based on the registration associated with each player stored on database 112. A player can change their player status at any time, wherein in response to determining a player has changed the player status of the player, Halloween program 110 stores the player status to the account associated with the player. In one embodiment, Halloween program 110 checks the player state of each player after a recurring period wherein the period is a predetermined amount of time. In one embodiment, Halloween program 110 generates a map of a neighborhood comprising locations corresponding to a set of active players and a plurality of inactive players. In a further embodiment, in response to determining a player among the plurality of players has a player state of being an active player, Halloween program 110 displays an active indicator at a location corresponding to an address associated with the active player on the generated map, wherein the active indicator can be a symbol (e.g., circle, square, or star) and a symbol color (e.g., green) to indicate that the active player associated with the location is currently participating in the event. Conversely, in response to determining a player among the plurality of players has a player state of being an inactive player, Halloween program 110 displays an inactive indicator at a location corresponding to an address associated with the inactive player on the generated map, wherein the active indicator can be a symbol (e.g., circle, square, X, or star) with a symbol color (e.g., red) to indicate that the inactive player associated with the location is currently not participating in the event. In one embodiment, a plurality of collectors can refer to the generated map displayed on a collector device 106 respective to each collector to determine the location of the set of active players and the location of plurality of inactive players.

In an even further embodiment, Halloween program 110 determines an active player among the plurality of players has a player status of grand prize active player by checking the player state. In this embodiment, a player selects a player status of grand prize active player, wherein a grand prize active player indicates that the player has a unique prize to give to a collector. In this embodiment, in response to determining an active player has a player status of grand prize active player, Halloween program 110 overlays a region on the generated map, wherein the region contains the location of the grand prize active player and locations corresponding to locations of a set of active players who are not the grand prize active player. In this embodiment, the region indicates to the plurality of collectors only an approximate location of the grand prize active player such that the plurality of collectors must search for grand prize active player among the active players located within the region to determine which of the active players is the grand prize active player. In this embodiment, the region is a shape (e.g., a circle, a square, or any configurable polygon) wherein the size or radius of the shape is a predetermine distance, and wherein the placement of the region on the generated map is randomly positioned to include the grand prize active player within the region. In a further embodiment, the size or radius of the shape is configured to include the location of the grand prize active player and at least one active player who is not a grand price active player.

In another embodiment, Halloween program informs an active player when a collector is approaching for collection. In this embodiment, 110 determines locations corresponding to each collector of the plurality of collectors, determines the location of a collector among the plurality of collectors is within a predetermined radius of an active player, and displays a message on player device 104 associated with the active player that the collector is located within the predetermined radius. The predetermined radius is a distance each active player may select, thus giving the respective active player time to prepare for an approaching collector that has entered within the predetermined radius.

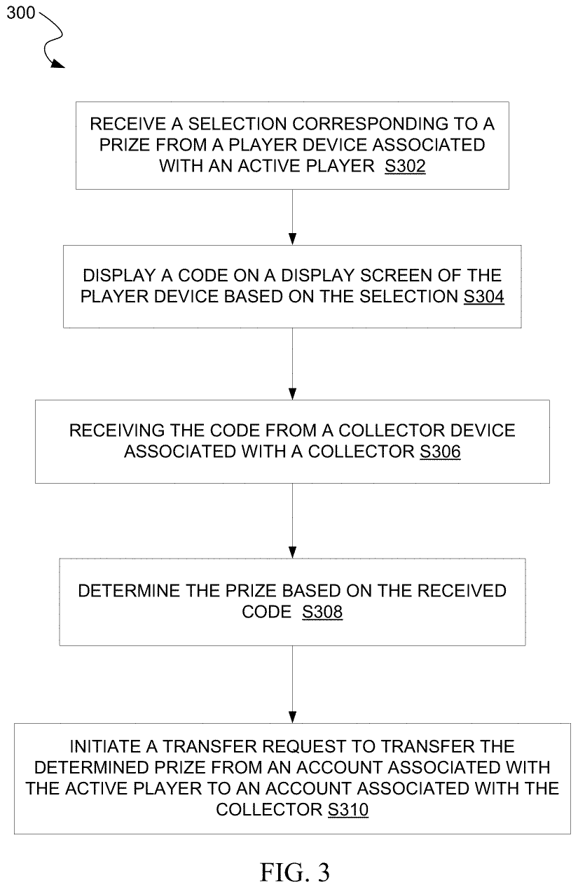

In step S206, Halloween program 110 determines a transfer request of a prize between a collector and an active player among the set of active players. In this embodiment, Halloween program 110 determines a transfer request by receiving a selection corresponding to a prize from player device 104 associated with an active player, displaying a code on the player device based on the selection, receiving the code from collector device 106 associated with a collector, determining the prize based on the received code, and initiating a transfer request to transfer the determined prize from an account associated with the active player to an account associated with the collector as described in greater detail with regards to FIG. 3, flowchart 300.

In step S208, Halloween program 110 executes a transfer based on the determined transfer request. In this embodiment, Halloween program 110 executes a transfer based on the determined transfer request by transferring the determined prize from the account associated with the active player to an account associated with the collector. In this embodiment, Halloween program 110 executes a transfer based on a queue of transfer requests, wherein a transfer request among a set of transfer requests comprises, but is not limited to, data identifying the account associated with the active player, data identifying the account associated with the collector, and data identifying a prize.

FIG. 3 is a flowchart 300 depicting operational steps of determining a transfer request of a prize between an active player and a collector, in accordance with an embodiment of the present invention.

In step S302, Halloween program 110 receives a selection corresponding to the prize from player device 104 associated with an active player. In this embodiment, an active player selects on player device 104 a prize to transfer from an account associated with the active player to an account associated with a collector. Upon the active player selecting a prize, Halloween program 110 receives the selection associated with the prize. In a further embodiment, the prize is the grand prize.

In step S304, Halloween program 110 displays a code on player device 104 associated with the active player based on the received selection. In this embodiment, Halloween program 110 generates a code (e.g., bar code or QR code) that is associated with the received selection (i.e., the prize) and displays the code on the display on player device 104. In a further embodiment, the code corresponds to a grand prize. In one embodiment, the generated code is linked to the active player by storing a data file on database 112 that links the generated code to the active player and the corresponding selected prize.

In step S306, Halloween program 110 receives the code from collector device 106 associated with the collector. In this embodiment, Halloween program 110 receives the code from collector device 106 by scanning the code displayed on player device 104 via a camera on collector device 106. In this embodiment, the active player allows the collector to use collector device 106 to scan the display screen of player device 104 that displays the code corresponding to the selected prize.

In step S308, Halloween program 110 determines the prize based on the code. In this embodiment, Halloween program 110 determines the prize based on the code by matching the received code to the code stored on database 112 based on the stored data file that links the generated code to the active player and the corresponding selected prize, thus determining the prize to be transferred from an account of the active player to the account of the collector.

In step S310, Halloween program 110 initiates a transfer request to transfer the determined prize from the account associated with the active player to an account associated with the collector. In this embodiment, Halloween program 110 initiates a transfer request by queuing a transfer request for execution, wherein the transfer request comprises, but is not limited to, data identifying the account associated with the active player, data identifying the account associated with the collector, and data identifying the prize.

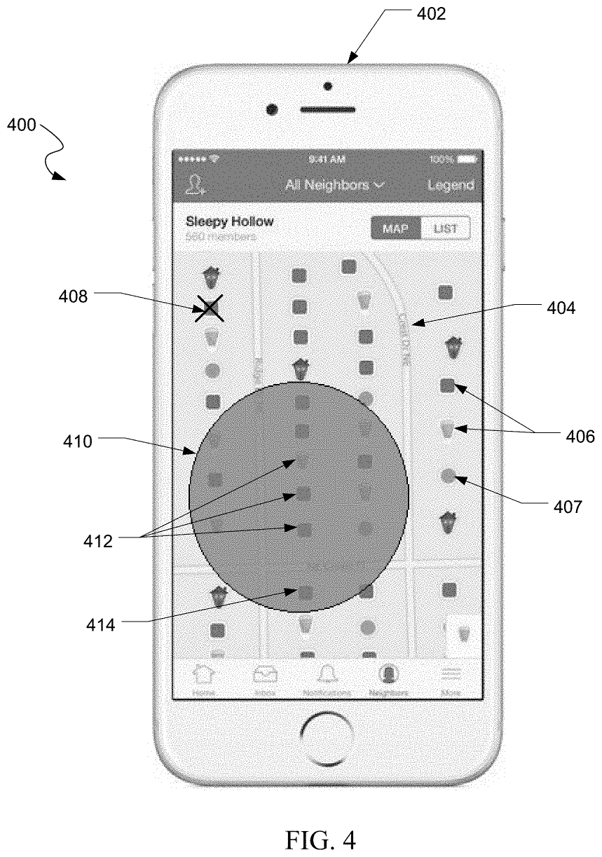

FIG. 4 is an example screenshot 400 of neighborhood map displaying a set of active players and a region containing a location of a grand prize, in accordance with an embodiment of the present invention.

In general, a neighborhood map displays a set of active players, a set of inactive players, a region containing a location of a grand prize, and set of houses that collectors should avoid. In this figure, mobile device 402 serves as collector device 106 where Halloween program 110 displays on a display of mobile device 402 a neighborhood map showing streets 404 of a neighborhood for a Halloween event. In this example, Halloween program 110 displays locations of active players indicated by graphical icons 406. In this embodiment, a player selects a player state of being a “active player” and can further choose an icon to match a theme of the player (e.g., candy corn, pumpkin, square, etc.) In this example, Halloween program 110 displays graphical icons 406 as a candy corn, a square, and a house, which indicate that the locations corresponding to the locations of graphical icons 406 indicate active players. In this embodiment, a player selects a player state of being an “inactive player”. In this example, Halloween program 110 displays graphical icon 407 as a circle, which indicate that the location of graphical icon 407 indicate an inactive player. In this embodiment, a player selects a player state of being a “grand prize active player”. In this example, Halloween program 110 displays region 410 that contains graphical icons 412 and graphical icon 414 wherein graphical icons 412 correspond to locations of active players and graphical icon 414 corresponds to a location of a grand prize active player. Further in this example, the graphical icon 414 is of similar form as the graphical icons 412 as to disguise to the collector which icon among graphical icon 414 and graphical icons 412 is the actual grand prize active player. In this embodiment, Halloween program 110 displays graphical icons that indicate a set of houses that collectors should avoid. For example, Halloween program 110 can obtain via the Internet a list of persons and corresponding addresses listed on a registered sex offender list. Halloween program 110 can in turn display locations of such persons on the list using a graphical icon to inform collectors to avoid the corresponding locations. In this example, Halloween program 110 displays graphical icon 108 to indicate to the collector to avoid the house at the corresponding location.

In some instances, Halloween program 110 can display augmented reality on a display screen on a device that corresponds to a theme selected by the player. For example, Halloween program 110 receives from player device 104 a haunted house theme selection for a player associated with player device 104 and stores the selection to database 112 to be associated with a house location of the player. Later, a collector associated with collector device 106 uses a camera and a display screen of collector device 106 to view a house of the player with the haunted house theme. Halloween program 110 determines the collector is proximate to the house location of the player. Responsive to determining the collector is proximate to the house location of the player, Halloween program 110 reads database 112 to determine a theme associated with the house by determining the stored selection associated with the player. Responsive to determining the selected theme, Halloween program 110 generates an augmented reality theme onto images captured by the camera of collector device 106 and displays the images having the generated augmented reality theme on the display screen, wherein the augmented reality theme corresponds to the determined stored selection. For example, for images captured of the house associated with the player that selected the haunted house theme, Halloween program 110 overlays images of ghosts in windows and gravestones in a front yard of the house. This permits the collector to have an immersive experience that the house they are approaching is haunted. Other themes may include, but is not limited to, a witch theme, a candy land theme, or mad scientist theme.

FIG. 5 depicts a block diagram of components of computing systems within exchange environment 100 of FIG. 1, in accordance with an embodiment of the present invention. It should be appreciated that FIG. 5 provides only an illustration of one implementation and does not imply any limitations with regard to the environments in which different embodiments can be implemented. Many modifications to the depicted environment can be made.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Computer system 500 includes communications fabric 502, which provides communications between cache 516, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses or a crossbar switch.

Memory 506 and persistent storage 508 are computer readable storage media. In this embodiment, memory 506 includes random access memory (RAM). In general, memory 506 can include any suitable volatile or non-volatile computer readable storage media. Cache 516 is a fast memory that enhances the performance of computer processor(s) 504 by holding recently accessed data, and data near accessed data, from memory 506.

Halloween program 110 may be stored in persistent storage 508 and in memory 506 for execution by one or more of the respective computer processors 504 via cache 516. In an embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Halloween program 110 may be downloaded to persistent storage 508 through communications unit 510.

I/O interface(s) 512 allows for input and output of data with other devices that may be connected to server computer 102, player device 104, and/or collector device 106. For example, I/O interface 512 may provide a connection to external devices 518 such as a keyboard, keypad, a touch screen, a microphone, and/or some other suitable input device. External devices 518 can also include portable computer readable storage media such as, for example, thumb drives, portable optical or magnetic disks, and memory cards. Software and data used to practice embodiments of the present invention, e.g., Halloween program 110, can be stored on such portable computer readable storage media and can be loaded onto persistent storage 508 via I/O interface(s) 512. I/O interface(s) 512 also connect to a display 520.

Display 520 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A computer-implemented method comprising:
receiving registration corresponding to each player of a plurality of players;
determining a set of active players and a set of inactive players among the plurality of players;
determining a transfer request of a prize between a collector and an active player among the set of active players; and
executing a transfer based on the determined transfer request.

2. The computer-implemented method of claim 1, wherein determining a transfer request of a prize between a collector and an active player among the set of active players comprises:
receiving a selection from a device associated with an active player, the selection corresponding to a prize;
displaying a code on a display screen of the player device based on the selection;
receiving the code from a collector device associated with a collector;
determining the prize based on the received code; and
initiating a transfer request to transfer the determined prize from an account associated with the active player to an account associated with the collector.

3. The computer-implemented method of claim 1, further comprising:
determining a set of locations corresponding to the determined set of active players; and
displaying a map on a device associated with the collector, the map showing the set of locations corresponding to the determined set of active players.

4. The computer-implemented method of claim 3, further comprising:
determining a grand prize active player among the set of active players that is offering a grand prize;
determining a location associated with the grand prize active player; and
displaying a region on the map that includes the location of the grand prize active player.

5. The computer-implemented method of claim 4, wherein the displayed region includes at least one active player that is not the grand prize active player.

6. The computer-implemented method of claim 1, further comprising:
determining a location corresponding to the collector;
determining the location corresponding to the collector is within a predetermined radius of an active player among the set of active players; and
displaying a message on a display of a device associated with the active player, the message informing the active player that the collector is located within the predetermined radius.

7. The computer-implemented method of claim 1, wherein the predetermined radius is selectable by the active player.

8. A computer program product comprising:
one or more computer readable storage media and program instructions stored on the one or more computer readable storage media, the program instructions comprising:
program instructions to receive registration corresponding to each player of a plurality of players;
program instructions to determine a set of active players and a set of inactive players among the plurality of players;
program instructions to determine a transfer request of a prize between a collector and an active player among the set of active players; and
program instructions to execute a transfer based on the determined transfer request.

9. The computer program product of claim 8, wherein the program instructions to determine a transfer request of a prize between a collector and an active player among the set of active players comprises:
program instructions to receive a selection from a device associated with an active player, the selection corresponding to a prize;
program instructions to display a code on a display screen of the player device based on the selection;
program instructions to receive the code from a collector device associated with a collector;
program instructions to determine the prize based on the received code; and
program instructions to initiate a transfer request to transfer the determined prize from an account associated with the active player to an account associated with the collector.

10. The computer program product of claim 8, further comprising:
program instructions to determine a set of locations corresponding to the determined set of active players; and
program instructions to display a map on a device associated with the collector, the map showing the set of locations corresponding to the determined set of active players.

11. The computer program product of claim 10, further comprising:
program instructions to determine a grand prize active player among the set of active players that is offering a grand prize;
program instructions to determine a location associated with the grand prize active player; and
program instructions to display a region on the map that includes the location of the grand prize active player.

12. The computer program product of claim 11, wherein the displayed region includes at least one active player that is not the grand prize active player.

13. The computer program product of claim 8, further comprising:
program instructions to determine a location corresponding to the collector;
program instructions to determine the location corresponding to the collector is within a predetermined radius of an active player among the set of active players; and
program instructions to display a message on a display of a device associated with the active player, the message informing the active player that the collector is located within the predetermined radius.

14. The computer program product of claim 13, wherein the predetermined radius is selectable by the active player.

15. A computer system comprising:
one or more computer processors;
one or more computer readable storage media; and
program instructions stored on the one or more computer readable storage media for execution by at least one of the one or more processors, the program instructions comprising:
program instructions to receive registration corresponding to each player of a plurality of players;
program instructions to determine a set of active players and a set of inactive players among the plurality of players;
program instructions to determine a transfer request of a prize between a collector and an active player among the set of active players; and
program instructions to execute a transfer based on the determined transfer request.

16. The computer system of claim 15, wherein the wherein the program instructions to determine a transfer request of a prize between a collector and an active player among the set of active players comprises:
program instructions to receive a selection from a device associated with an active player, the selection corresponding to the prize;
program instructions to display a code on a display screen of the player device based on the selection;
program instructions to receive the code from a collector device associated with a collector;
program instructions to determine the prize based on the received code; and
program instructions to initiate a transfer request to transfer the determined prize from an account associated with the active player to an account associated with the collector.

17. The computer system of claim 15, further comprising:
program instructions to determine a set of locations corresponding to the determined set of active players; and
program instructions to display a map on a device associated with the collector, the map showing the set of locations corresponding to the determined set of active players.

18. The computer program product of claim 17, further comprising:
program instructions to determine a grand prize active player among the set of active players that is offering a grand prize;
program instructions to determine a location associated with the grand prize active player; and
program instructions to display a region on the map that includes the location of the grand prize active player.

19. The computer program product of claim 18, wherein the displayed region includes at least one active player that is not the grand prize active player.

20. The computer program product of claim 15, further comprising:
program instructions to determine a location corresponding to the collector;
program instructions to determine the location corresponding to the collector is within a predetermined radius of an active player among the set of active players; and
program instructions to display a message on a display of a device associated with the active player, the message informing the active player that the collector is located within the predetermined radius.
